(19) United States
(12) Patent Application Publication
(10) Pub. No.: US 2021/0341151 A1
(43) Pub. Date: Nov. 4, 2021

(54) INDICATOR ASSEMBLY

(71) Applicant: WHIRLPOOL CORPORATION, BENTON HARBOR, MI (US)

(72) Inventors: Monica C. Monteiro, Joinville (BR); Rafael C. Prado, Joinville (BR); Nilvania Stefanello, Joinville (BR); Gustavo Ernesto Ferreira dos Santos, Campina Grande (BR)

(73) Assignee: WHIRLPOOL CORPORATION, BENTON HARBOR, MI (US)

(21) Appl. No.: 17/227,434

(22) Filed: Apr. 12, 2021

Related U.S. Application Data
(60) Provisional application No. 63/017,727, filed on Apr. 30, 2020.

(51) Int. Cl. F24C 7/08; F21V 23/00; F21V 7/04; F21V 33/00

(52) U.S. Cl. CPC F24C 7/083; F21V 33/0044; F21V 7/04; F21V 23/003

(57) ABSTRACT

A cooktop for an appliance includes a body that has a support surface. A cooking surface is operably coupled to the body and defines a plurality of indicia. A plurality of coils are coupled to the support surface of the body. The plurality of coils correspond with the plurality of indicia defined by the cooking surface. An indicator assembly is operably coupled to the support surface of the body. The indicator assembly includes reflective members that are disposed on the support surface proximate to the plurality of coils and lasers are operably coupled to the support surface and are disposed proximate the reflective members. A controller is operably coupled to the indicator assembly and is configured to activate the lasers relative to the reflective members.

### CROSS REFERENCE TO RELATED APPLICATION

This application claims the benefit under 35 U.S.C. § 119(e) to U.S. Provisional Patent Application No. 63/017,727, filed Apr. 30, 2020, entitled “INDICATOR ASSEMBLY,” which is incorporated herein by reference in its entirety.

### BACKGROUND OF THE DISCLOSURE

The present disclosure generally relates to a cooktop for an appliance, and more specifically, to an indicator assembly for a cooktop.

### SUMMARY OF THE DISCLOSURE

According to one aspect of the present disclosure, a cooktop for an appliance includes a body that has a support surface. A cooking surface is operably coupled to the body and defines a plurality of indicia. A plurality of coils are coupled to the support surface of the body. The plurality of coils correspond with the plurality of indicia defined by the cooking surface. An indicator assembly is operably coupled to the support surface of the body. The indicator assembly includes reflective members that are disposed on the support surface proximate to the plurality of coils and lasers are operably coupled to the support surface and are disposed proximate the reflective members. A controller is operably coupled to the indicator assembly and is configured to activate the lasers relative to the reflective members.

According to another aspect of the present disclosure, an indicator assembly for a cooktop includes a support surface. Reflective members are operably coupled to the support surface. An illumination feature is operably coupled to a first end of each of the reflective members and define a light path along each of the reflective members. A barrier member is centrally disposed on the support surface proximate a second end of each of the reflective members.

According to another aspect of the present disclosure, an indicator assembly for a cooktop includes a support surface. Reflective members are disposed on the support surface and have a first end and a second end. Each of the reflective members has a first bend and a second bend that are defined between the first end and the second end of each of the reflective members. A first deflector is disposed on the first bend of each of the reflective members. A second deflector is disposed on the second bend of each of the reflective members. An illumination feature is operably coupled to each of the reflective members and define a light path proximate each of the reflective members.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of a cooktop of the present disclosure coupled to an appliance;

FIG. 2 is a top plan view of a cooktop of the present disclosure that has a glass-ceramic surface;

FIG. 3 is a cross-sectional view of the cooktop of FIG. 2 taken along lines III-Ill;

FIG. 4 is a top plan view of the cooktop of FIG. 2 with the glass-ceramic surface removed to illustrate a plurality of coils and an indicator assembly of the present disclosure that has a first deflector and a second deflector;

FIG. 5 is an enlarged partial top plan view of the indicator assembly of FIG. 4 taken at area V;

FIG. 6 is a top plan view of a cooktop of the present disclosure with a light path that defines activated cooking areas;

FIG. 7 is a top plan view of a plurality of coils and an indicator assembly of the present disclosure that has a barrier member; and

FIG. 8 is a top plan view of a cooktop of the present disclosure with light paths that define activated cooking areas.

The components in the figures are not necessarily to scale, emphasis instead being placed upon illustrating the principles described herein.

### DETAILED DESCRIPTION

The present illustrated embodiments reside primarily in combinations of apparatus components related to an indicator assembly for a cooktop. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

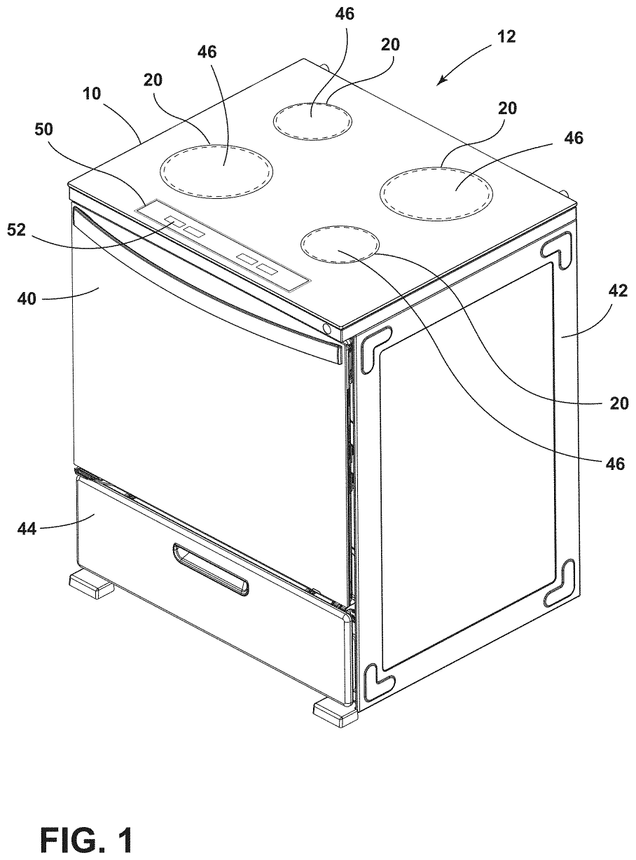

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

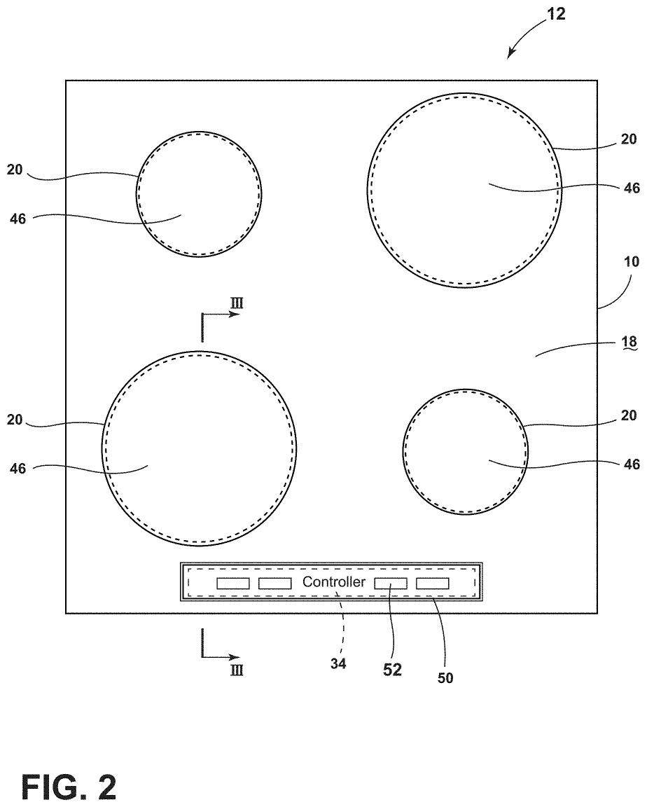

Referring to FIGS. 1-8, reference numeral 10 generally designates a cooktop for an appliance 12 that includes a body 14 that has a support surface 16. A cooking surface 18 is operably coupled to the body 14 and defines a plurality of indicia 20. A plurality of coils 22 are operably coupled to the support surface 16 of the body 14. The plurality of coils 22 correspond with the plurality of indicia 20 defined by the cooking surface 18. An indicator assembly 24 is operably coupled to the support surface 16 of the body 14. The indicator assembly 24 includes reflective members 26 disposed on the support surface 16 proximate to the plurality of coils 22. Lasers 32 are operably coupled to the support surface 16 and are disposed proximate the reflective members 26. A controller 34 is operably coupled to the indicator assembly 24 and is configured to activate the lasers 32 relative to the reflective members 26.

Referring to FIGS. 1-3, the cooktop 10 includes a glass-ceramic surface coupled to the support surface 16 of the cooktop 10 through which the indicator assembly 24 is selectively visible, as described below. The cooktop 10 is illustrated as being disposed on the appliance 12 proximate to a door 40 and coupled to an appliance body 42. As illustrated, the appliance 12 includes, in addition to the door 40 and the appliance body 42, a warming drawer 44 positioned beneath the door 40 of the appliance 12. Although the cooktop 10 is illustrated as being coupled to the appliance body 42 of the appliance 12, it is also contemplated that the cooktop 10 may be separate from the appliance 12, such that the cooktop 10 can be disposed on a countertop surface. For example, the body 14 of the cooktop 10 can be coupled to a countertop surface to independently support the cooktop 10 from the appliance 12.

It is generally contemplated that the cooktop 10 is an induction cooktop, such that each of the coils 22 is associated with a burner area 46 that generates a constantly changing electromagnetic field configured to interact with a metal cooking utensil placed on the burner area 46. However, it is also contemplated that the indicator assembly 24 described herein may be used in other cooktops, such as gas-operated cooktops. The burner area 46 may be at least partially defined by the plurality of indicia 20 defined along the cooking surface 18 of the cooktop 10. It is generally contemplated that the cooking surface 18 may be a glass-ceramic surface, such that the indicator assembly 24 can be selectively visible through the cooking surface 18, described further below. The indicia 20 generally indicate the position of each coil 22 beneath the cooking surface 18. While the indicia 20 indicates the location of each burner area 46, the indicator assembly 24 indicates which burner area 46 is in use, as described below.

With further reference to FIGS. 1-3, the cooktop 10 includes a user interface 50 disposed on and operably coupled to the cooking surface 18. The user interface 50 is positioned proximate to the door 40 of the appliance 12 and is operably coupled to the controller 34 to provide controls for a user to operate the cooktop 10. The user interface 50 includes tactile indicia 52 communicatively coupled to the controller 34 to activate at least one of the coils 22 and simultaneously activate the indicator assembly 24. For example, the user interface 50 is also operably coupled with the indicator assembly 24 via the controller 34 to operate the lasers 32, as described in more detail below. The coupling of the indicator assembly 24 with the user interface 50 further defines the selected burner area 46, described in further detail below.

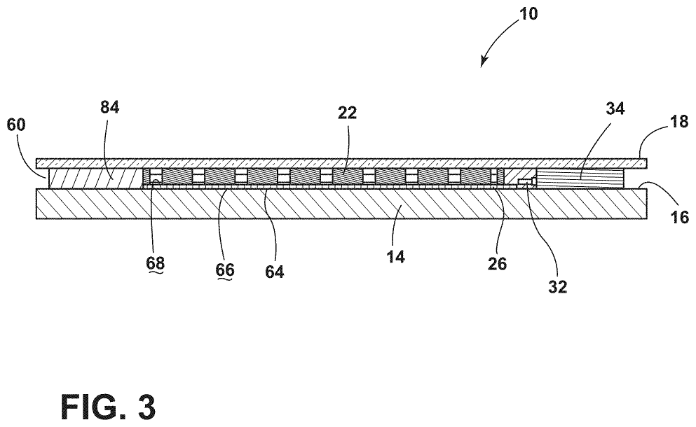

Referring now to FIGS. 3-6, a space 60 is defined between the support surface 16 and the cooking surface 18 in which the indicator assembly 24 and the plurality of coils 22 are disposed. The space 60 is typically a height sufficient to contain the coils 22 and the indicator assembly 24, but is compact to minimize the bulk of the overall cooktop 10. Each of the plurality of coils 22 is coupled to the support surface 16 via retention clips 62, and each coil 22 can be surrounded by one of the reflective members 26 to generally define a U-shaped configuration around each coil 22. The reflective members 26 are disposed on and coupled to the support surface 16. It is generally contemplated that the reflective members 26 are coupled to the support surface 16 via an adhesive 64 disposed on a bottom surface 66 of the reflective members 26. The bottom surface 66 of the reflective members 26 is configured to adhere the reflective members 26 to the support surface 16 via the adhesive 64. A top surface 68 of the reflective members 26 is formed from a reflective material configured to reflect light, as described in more detail below. For example, the reflective members 26 can be formed from strips of reflective tape, such that the bottom surface 66 of the reflective members 26 includes the adhesive 64 that is configured to adhere to the support surface 16 and the top surface 68 includes the reflective material. Additionally or alternatively, the reflective members 26 may be coupled to the support surface 16 via other fastening methods, such as separate adhesive strips, screws, magnets, and other practicable fasteners.

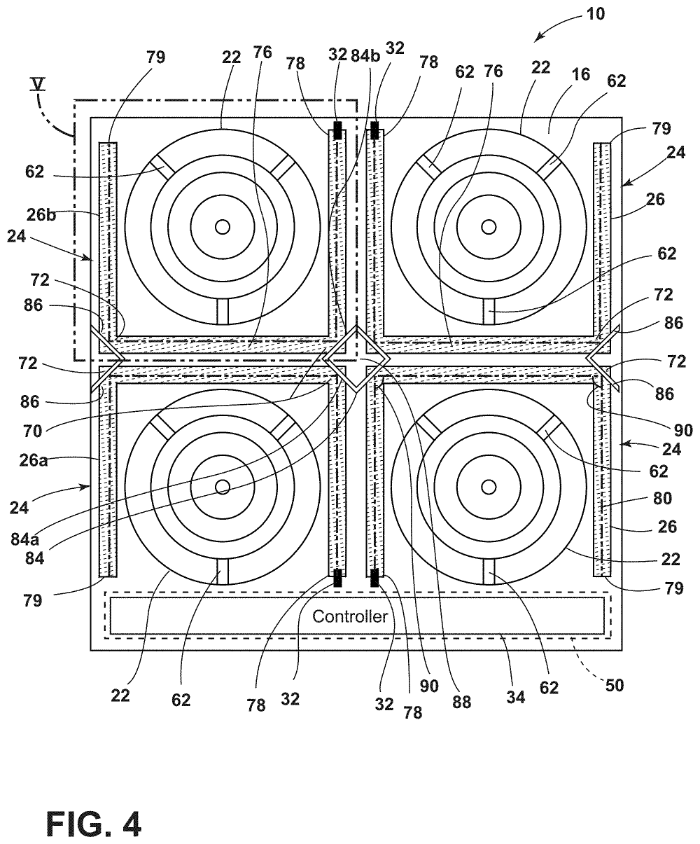

The reflective members 26, as illustrated in FIG. 4, include a first bend 70 and a second bend 72. It is generally contemplated that the first bend 70 and the second bend 72 are generally orthogonal. Additionally or alternatively, it is also contemplated that the first bend 70 and the second bend 72 may be curved, rounded, or any other orientation to be disposed around the coils 22. As illustrated in FIG. 4, the reflective members 26 each include first and second lateral portions 74a, 74b and a medial portion 76 extending between the lateral portions 74a, 74b. The first bend 70 and the second bend 72 are defined where the lateral portions 74a, 74b are coupled to the medial portion 76, respectively. Stated differently, the medial portion 76 of each reflective member 26 extends between the lateral portions 74a, 74b to define the first bend 70 and the second bend 72 of each of the reflective members 26. The reflective members 26 may generally cooperate with the indicia 20 disposed on the cooking surface 18 to illuminate the selected burner area 46. For example, the selected burner area 46 indicated by one of the indicia 20 can be illuminated by the indicator assembly 24, described in further detail below.

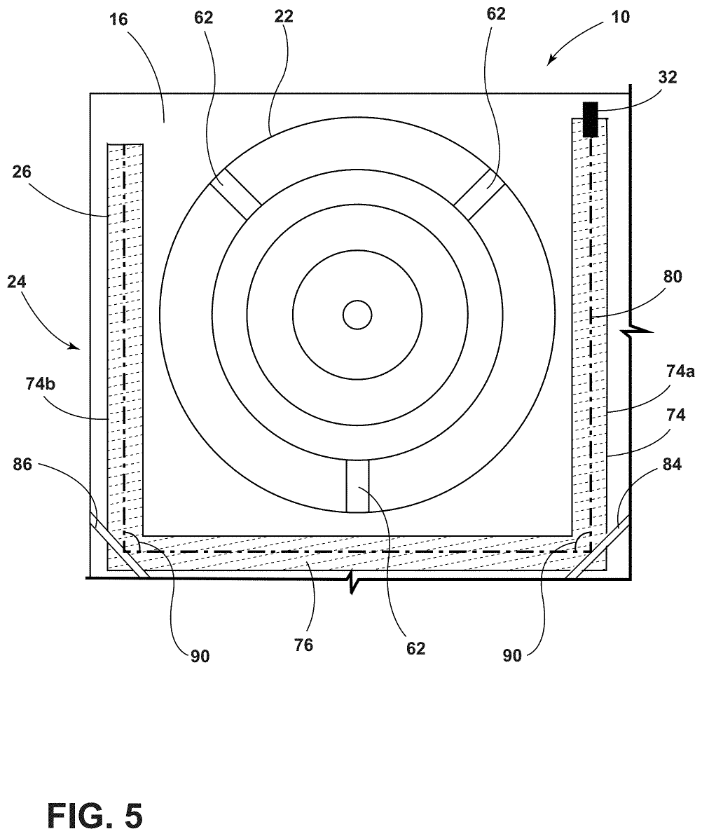

With specific reference to FIG. 5, one of the lasers 32 is positioned on a first end 78 of the illustrated reflective member 26, such that a light path 80 of the laser 32 is reflected by the reflective member 26. Additionally or alternatively, the laser 32 may be positioned on a second end 79 of the reflective member 26 to define the light path 80. The light path 80 of the laser 32 is enhanced by the reflective member 26 to transmit the light path 80 through the cooking surface 18 of the cooktop 10 to define an activated cooking area 82, described below. It is generally contemplated that the lasers 32 may be referred to as an illumination feature, such that a first illumination feature 32 may be coupled to a first reflective member 26a and a second illumination feature 32 may be coupled to a second reflective member 26b. The light path 80 is reflected by the reflective member 26, such that the light path 80 of the indicator assembly 24 is visible through the cooking surface 18 to illuminate the activated cooking area 82.

Referring still to FIGS. 4-6, the laser 32 is operably coupled to the controller 34 of the user interface 50 to selectively display the light path 80. The controller 34 is configured to receive a signal from the user interface 50 as a result of the user selecting one of the burner areas 46 for use. Upon selection of one of the burner areas 46, the controller 34 activates at least one laser 32 to disperse the light path 80 along the respective reflective member 26. Stated differently, the activation of the indicator assembly 24 by the controller 34 indicates the activated cooking area 82 by outlining the burner area 46 with the light path 80 of the laser 32.

As mentioned above, the indicator assembly 24 includes the reflective members 26 and the lasers 32. It is also contemplated that the indicator assembly 24 can include a first deflector 84 and a second deflector 86, as illustrated in FIGS. 4 and 5. The first and second deflectors 84, 86 of the indicator assembly 24 are positioned on the first and second bends 70, 72, respectively, of each of the reflective members 26 to direct the light path 80 along the respective reflective member 26 and define the activated cooking area 82. Stated differently, the first deflector 84 and the second deflector 86 help to further define the activated cooking area 82 by deflecting the light path 80 of the laser 32 along the reflective member 26.

As illustrated in FIG. 5, the first deflector 84 is coupled to the support surface 16 and is disposed on the first bend 70 of each reflective member 26. For example, the reflective members 26 can include a first reflective member 26a and a second reflective member 26b. A first portion 84a of the first deflector 84 is disposed on the first bend 70 of the first reflective member 26a, and a second portion 84b of the first deflector 84 can be disposed on the first bend 70 of the second reflector 26b. Similarly, the second deflector 86 is coupled to the support surface 16 and is disposed on the second bend 72 of each reflective member 26. The first and second deflectors 84, 86 are formed from a reflective material, such as a mirror, to reflect the light path 80 of each laser 32, described below. In addition, the first and second deflectors 84, 86 are generally compact to fit within the space 60 defined between the support surface 16 and the cooking surface 18 while maintaining the compact construction of the cooktop 10. The first deflector 84 and the second deflector 86 are depicted as separate deflectors positioned along the reflective members 26.

For example, the first deflector 84 is illustrated in FIG. 4 as being simultaneously disposed on the first bend 70 for each of the reflective members 26, such that the first deflector 84 has a box-like configuration. In this configuration, the first deflector 84 is centrally disposed on a central portion 88 of the support surface 16 and disposed on each first bend 70 of each reflective member 26. The second deflector 86 is depicted in FIG. 4 as being an L-shaped deflector positioned on the second bend 72 of each of the reflective members 26, such that the second deflector 86 is simultaneously positioned on the second bend 72 of two of the reflective members 26. As depicted, there are multiple second deflectors 86 disposed on the support surface 16, such that there is one second deflector 86 for every two reflective members 26. Additionally or alternatively, each first deflector 84 and each second deflector 86 may be separately disposed on each reflective member 26, such that the first and second deflectors 84, 86 are each a single planar deflective member, such as a mirror.

With further reference to FIGS. 4-6, the laser 32 is disposed on the first end 78 of the reflective member 26 and is directed toward the first deflector 84 located at the first bend 70 of the reflective member 26. As disclosed herein, the first and second deflectors 84, 86 can be mirrors, such that the light path 80 of the laser 32 is reflected and/or deflected by the mirrored surface of the first deflector 84 along the medial portion 76 of the reflective member 26 toward the second deflector 86 at the second bend 72 of the reflective member 26. The second deflector 86 similarly reflects the light path 80 of the laser 32 along one of the lateral portions 74a, 74b of the reflective member 26 toward the second end 79 of the reflective member 26. The light path 80 that is reflected by the first deflector 84 and/or the second deflector 86 is reflected at the same angle at which the light path 80 first contacts either of the first deflector 84 or the second deflector 86. This reflection may also be referred to as a deflection angle 90 of the light path 80 as the light path 80 is deflected, or redirected, by the first and second deflectors 84, 86.

The deflection angle 90 of the light path 80 is defined as the angle taken between the light path 80 along one of the lateral portions 74a, 74b of the reflective member 26 and the light path 80 reflected off of the respective first deflector 84 or second deflector 86 along the medial portion 76 of the reflective member 26. Stated differently, the laser 32 projects the light path 80 along one of the lateral portions 74a, 74b of the reflective member 26 toward the first deflector 84, and the light path 80 is deflected by the first deflector 84 along the medial portion 76 of the reflective member 26 toward the second deflector 86. The second deflector 86 can then deflect the light path 80 again along the lateral portion 74a, 74b of the reflective member 26. The deflection angles 90 are defined by the point in which the light path 80 is deflected by each of the first and second deflectors 84, 86.

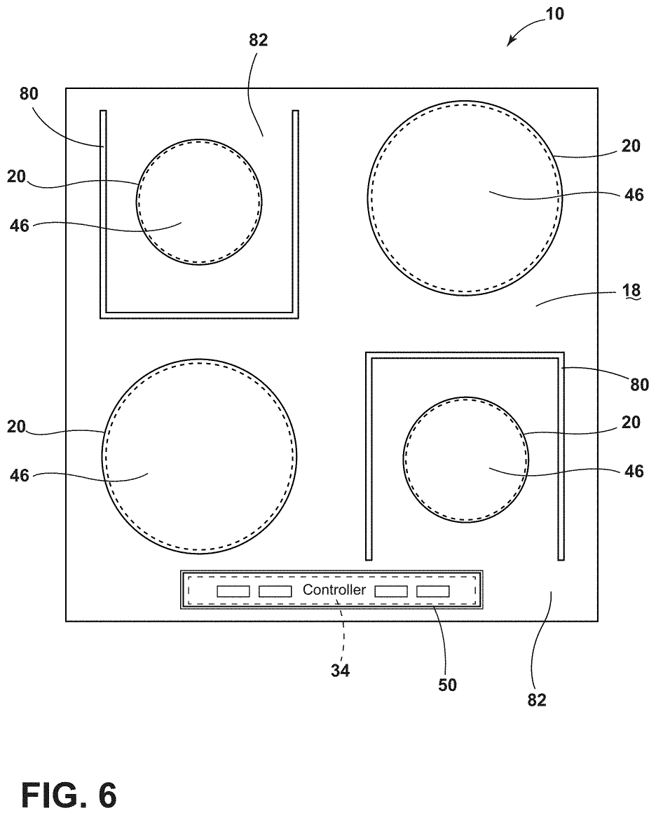

Referring still to FIGS. 4-6, the deflection angles 90 of the light path 80 as reflected by the first and second deflectors 84, 86 forms a general U-shape of the indicator assembly 24 to illuminate the activated cooking area 82, as illustrated in FIG. 6. Although the deflection angles 90 are depicted as an approximately 90-degree angle, it is generally contemplated that the first and second deflectors 84, 86 can be adjusted to a variety of angles, such that the indicator assembly 24 may project a different shape while still indicating the activated cooking area 82. As mentioned, the light path 80 of the laser 32 is deflected at the deflection angle 90 defined by each of the first deflector 84 and the second deflector 86. The deflection angle 90 of the indicator assembly 24 further defines the shape of the indicator assembly 24 around the coil 22 to illuminate the activated cooking area 82.

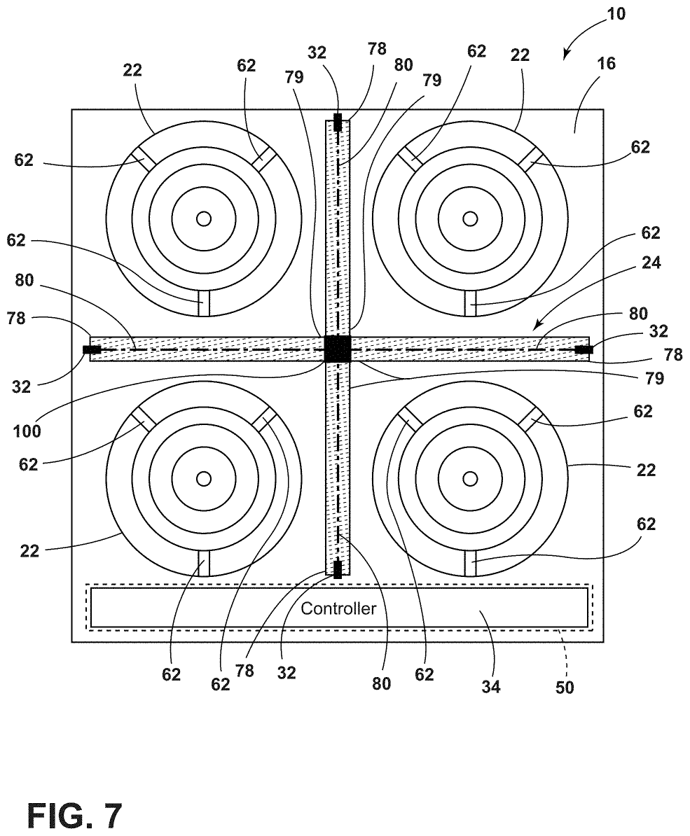

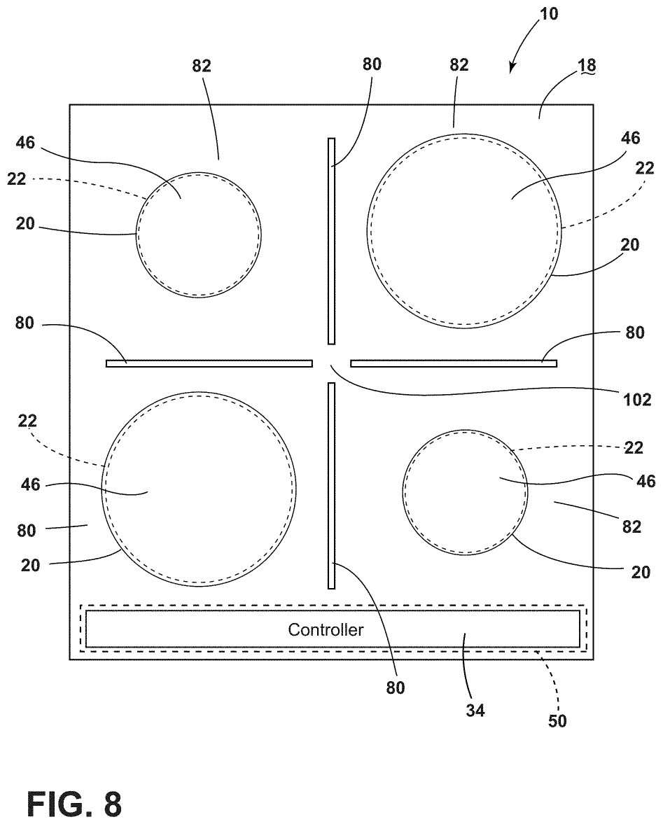

With reference now to FIGS. 7 and 8, the reflective members 26 are each depicted as a single reflective strip disposed in a cross-formation along the support surface 16, such that a single reflective member 26 of the indicator assembly 24 is disposed between each coil 22. As set forth herein, the laser 32 is disposed on the first end 78 of the reflective members 26. The second end 79 of each of the reflective members 26 extends toward the central portion 88 of the support surface 16. As compared to the light path 80 described with respect to FIGS. 4-6, the light path 80 depicted in FIGS. 7 and 8 is linear, such that the laser 32 directs the light path 80 directly from the first end 78 to the second end 79 of each of the reflective members 26. The light path 80 is ultimately obstructed by a barrier member 100 that is disposed on the central portion 88 of the support surface 16.

The barrier member 100 is centrally disposed on the support surface 16 with the reflective member 26 extending toward each side of the barrier member 100. The barrier member 100 is typically formed from a light-absorbing and heat resistant material, such that the barrier member 100 absorbs the light path 80 from the laser 32 while being able to withstand the heat of the coils 22. The position of the reflective members 26 in a cross-formation around the barrier member 100 defines the light pattern of the indicator assembly 24 in the depicted construction illustrated in FIG. 8.

With further reference to FIGS. 7 and 8, the laser 32 is positioned on the first end 78 of each of the reflective members 26 and is directed toward the barrier member 100. The light path 80 is illuminated along the reflective member 26 and visible through the cooking surface 18, while being absorbed or otherwise obstructed by the barrier member 100 proximate to the second end 79 of the reflective members 26. The barrier member 100 defines a separated appearance of the activated cooking areas 82, such that the reflective members 26 are oriented with the barrier member 100 defining a gap 102 between the second end 79 of each reflective member 26. The gap 102 is defined regardless of how many of the burner areas 46 are selected for use, such that the gap 102 can be defined by the selection of any one of the burner areas 46 alone or in combination. In the configuration depicted in FIGS. 7 and 8, two of the lasers 32 are activated by the controller 34 to illuminate the activated cooking area 82, as compared to the light path 80 of a single laser 32 being deflected to identify the activated cooking area 82 as described with respect to FIGS. 4-6.

The configuration depicted in FIG. 8 is achieved by the user selecting the burner area 46 via the tactile indicia 52 on the user interface 50, and the controller 34 communicating with the indicator assembly 24 to activate the two lasers 32 adjacent to the selected burner area 46. The light path 80 from each of the two activated lasers 32 is directed toward the barrier member 100. The barrier member 100 absorbs the light emitted by each of the lasers 32 to define the segmented appearance of the indicator assembly 24 on the cooking surface 18. As illustrated in FIG. 8, two sides of the activated cooking area 82 are illuminated by the indicator assembly 24 to identify which burner area 46 the user selected.

Referring again to FIGS. 1-8, the indicator assembly 24 allows a user to quickly and easily identify which burner area 46 is selected for use. Induction cooktops 10, in particular, provide minimal indication of the activated cooking area 82, such that the indicia 20 are typically one of the primary identifiers of the location of the coils 22 beneath the cooking surface 18. Accordingly, the indicator assembly 24 assists the user to readily identify a particular activated cooking area 82 to distinguish the selected burner area 46 from the non-selected burner areas 46. The various configurations of the indicator assembly 24 allow the user to have varying design construction for illuminating the activated cooking area 82. For example, the indicator assembly 24 may include the first and second deflectors 84, 86 to provide the U-shape configuration of the indicator assembly 24. Alternatively, the indicator assembly 24 may incorporate the barrier member 100 to define the segmented configuration of the indicator assembly 24. In either configuration, the indicator assembly 24 helps the user easily identify the burner area 46 selected by the user. It is also contemplated that the barrier member 100 may be used in combination with the reflective members 26 illustrated in FIGS. 4-6.

The present disclosure disclosed herein is further summarized in the following paragraphs and is further characterized by combinations of any and all of the various aspects described therein.

According to one aspect of the present disclosure, a cooktop for an appliance includes a body that has a support surface. A cooking surface is operably coupled to the body and defines a plurality of indicia. A plurality of coils are coupled to the support surface of the body. The plurality of coils correspond with the plurality of indicia defined by the cooking surface. An indicator assembly is operably coupled to the support surface of the body. The indicator assembly includes reflective members that are disposed on the support surface proximate to the plurality of coils and lasers are operably coupled to the support surface and are disposed proximate the reflective members. A controller is operably coupled to the indicator assembly and is configured to activate the lasers relative to the reflective members.

According to another aspect, lasers define a light path proximate each reflective member.

According to another aspect, a cooktop further includes a barrier member that is centrally disposed on a support surface of a body proximate to an end of each reflective member.

According to another aspect, each reflective member includes a first end and a second end, and a first bend and a second bend are defined between the first end and the second end of each of the reflective members.

According to another aspect, an indicator assembly further includes a first deflector and a second deflector, and the first deflector is disposed on each reflective member at a first bend and the second deflector is disposed on each of the reflective members at a second bend.

According to another aspect, an indicator assembly is selectively visible through a cooking surface to define an activated cooking area.

According to another aspect, a controller is configured to activate lasers of an indicator assembly to define an activated cooking area, and the controller is communicatively coupled to a plurality of coils to activate at least one of the lasers to define the activated cooking area of the cooking surface.

According to another aspect of the present disclosure, an indicator assembly for a cooktop includes a support surface. Reflective members are operably coupled to the support surface. An illumination feature is operably coupled to a first end of each of the reflective members and define a light path along each of the reflective members. A barrier member is centrally disposed on the support surface proximate a second end of each of the reflective members.

According to another aspect, reflective members at least partially define a cooking area and are configured to be disposed around coils disposed on a support surface.

According to another aspect, a light path defined by an illumination feature extends along each reflective member and is configured to be obstructed by a barrier member.

According to another aspect, reflective members include a first reflective member and a second reflective member, and a first illumination feature is coupled to the first reflective member and a second illumination feature is coupled to the second reflective member.

According to another aspect, a light path defined by a first illumination feature along a first reflective member and the light path defined by a second illumination feature along a second reflective member define an activated cooking area.

According to another aspect, a light path defined by a first illumination feature and a second illumination feature is obstructed by a barrier member to further define an activated cooking area.

According to another aspect of the present disclosure, an indicator assembly for a cooktop includes a support surface. Reflective members are disposed on the support surface and have a first end and a second end. Each of the reflective members has a first bend and a second bend that are defined between the first end and the second end of each of the reflective members. A first deflector is disposed on the first bend of each of the reflective members. A second deflector is disposed on the second bend of each of the reflective members. An illumination feature is operably coupled to each of the reflective members and define a light path proximate each of the reflective members.

According to another aspect, each reflective member includes first and second lateral portions and a medial portion defined therebetween. A light path defined by an illumination feature is altered by a first deflector to extend along the medial portion of each of the reflective member and is altered by a second deflector to extend along at least one of the first and second lateral portions of each of the reflective members to define an activated cooking area.

According to another aspect, a first deflector and a second deflector comprise a reflective material configured to alter a light path defined by an illumination feature to define an activated cooking area.

According to another aspect, a first deflector is centrally disposed on a support surface and is operably coupled to a first bend of each reflective member.

According to another aspect, a deflection angle is defined by an alteration of a light path, and the deflection angle is defined by the light path and first and second deflectors to define a U-shape.

According to another aspect, reflective members include a first reflective member and a second reflective member. A first deflector includes a first portion disposed on a first bend of the first reflective member and a second portion disposed on a first bend of the second reflective member.

According to another aspect, an indicator assembly further includes a controller that is configured to activate an illumination feature to selectively define an activated cooking area along at least one of the reflective members.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooktop for an appliance, comprising:
a body having a support surface;
a cooking surface operably coupled to the body and defining a plurality of indicia;
a plurality of coils operably coupled to the support surface of the body, wherein the plurality of coils correspond with the plurality of indicia defined by the cooking surface;
an indicator assembly operably coupled to the support surface of the body, the indicator assembly including:
reflective members disposed on the support surface proximate to the plurality of coils; and
lasers operably coupled to the support surface and disposed proximate the reflective members; and
a controller operably coupled to the indicator assembly and configured to activate the lasers relative to the reflective members.

2. The cooktop of claim 1, wherein the lasers each define a light path proximate each of the reflective members.

3. The cooktop of claim 1, further comprising:
a barrier member centrally disposed on the support surface of the body proximate to an end of each of the reflective members.

4. The cooktop of claim 1, wherein each of the reflective members includes a first end and a second end, and wherein a first bend and a second bend are defined between the first end and the second end of each of the reflective members.

5. The cooktop of claim 4, wherein the indicator assembly further includes a first deflector and a second deflector, and wherein the first deflector is disposed on each of the reflective members at the first bend and the second deflector is disposed on each of the reflective members at the second bend.

6. The cooktop of claim 1, wherein the indicator assembly is selectively visible through the cooking surface to define an activated cooking area.

7. The cooktop of claim 6, wherein the controller is configured to activate the lasers of the indicator assembly to define the activated cooking area, and wherein the controller is communicatively coupled to the plurality of coils to activate at least one of the lasers to define the activated cooking area of the cooking surface.

8. An indicator assembly for a cooktop, comprising:
a support surface;
reflective members operably coupled to the support surface;
an illumination feature operably coupled to a first end of each of the reflective members and defining a light path along each of the reflective members; and
a barrier member centrally disposed on the support surface proximate a second end of each of the reflective members.

9. The indicator assembly of claim 8, wherein the reflective members at least partially define a cooking area and are configured to be disposed around coils disposed on the support surface.

10. The indicator assembly of claim 8, wherein the light path defined by the illumination feature extends along each of the reflective members and is configured to be obstructed by the barrier member.

11. The indicator assembly of claim 8, wherein the reflective members include a first reflective member and a second reflective member, and wherein a first illumination feature is coupled to the first reflective member and a second illumination feature is coupled to the second reflective member.

12. The indicator assembly of claim 11, wherein the light path defined by the first illumination feature along the first reflective member and the light path defined by the second illumination feature along the second reflective member define an activated cooking area.

13. The indicator assembly of claim 12, wherein the light path defined by each of the first illumination feature and the second illumination feature is obstructed by the barrier member to further define the activated cooking area.

14. An indicator assembly for a cooktop, comprising:
a support surface;
reflective members disposed on the support surface and having a first end and a second end, wherein each of the reflective members has a first bend and a second bend defined between the first end and the second end of each of the reflective members;
a first deflector disposed on the first bend of each of the reflective members;
a second deflector disposed on the second bend of each of the reflective members; and
an illumination feature operably coupled to each of the reflective members and defining a light path proximate each of the reflective members.

15. The indicator assembly of claim 14, wherein each of the reflective members includes first and second lateral portions and a medial portion defined therebetween, and wherein the light path defined by the illumination feature is altered by the first deflector to extend along the medial portion of each of the reflective members and is altered by the second deflector to extend along at least one of the first and second lateral portions of each of the reflective members to define an activated cooking area.

16. The indicator assembly of claim 14, wherein the first deflector and the second deflector comprise a reflective material configured to alter the light path defined by the illumination feature to define an activated cooking area.

17. The indicator assembly of claim 14, wherein the first deflector is centrally disposed on the support surface and operably coupled to the first bend of each of the reflective members.

18. The indicator assembly of claim 14, wherein a deflection angle is defined by an alteration of the light path, and wherein the deflection angle is defined by the light path and the first and second deflectors to define a U-shape.

19. The indicator assembly of claim 14, wherein the reflective members include a first reflective member and a second reflective member, and wherein the first deflector includes a first portion disposed on the first bend of the first reflective member and a second portion disposed on the second bend of the second reflective member.

20. The indicator assembly of claim 14, further comprising:
a controller configured to activate the illumination feature to selectively define an activated cooking area along at least one of the reflective members.
